(19) United States
(12) Patent Application Publication
(10) Pub. No.: US 2011/0267237 A1
(43) Pub. Date: Nov. 3, 2011

(54) Dual-band Mobile Communication Device and Antenna Structure Thereof

(76) Inventors: Kin-Lu Wong, Hsichih (TW); Wei-Yu Chen, Hsichih (TW)

(21) Appl. No.: 12/851,588

(22) Filed: Aug. 6, 2010

(30) Foreign Application Priority Data
May 3, 2010 (TW) 099114095

(51) Int. Cl. H01Q 5/00; H01Q 9/04; H01Q 1/24

(52) U.S. Cl. 343/702; 343/700 MS

(57) ABSTRACT

A dual-band mobile communication device includes a ground plane and an antenna. The antenna is located on a dielectric substrate and includes a feeding portion and a shorted radiating portion. One end of the feeding portion is a feeding point of the antenna. The A length of the shorted radiating portion is at least twice that of the feeding portion. One A first end of the shorted radiating portion, electrically connected to the ground plane, is a shorting end, and the other second end of the shorted radiating portion is an open end. The shorted radiating portion includes multiple bendings which form multiple fractional sections, wherein the open end of the shorted radiating portion extends toward a first fractional section of the shorting end of the shorted radiating portion. A coupling gap is existed between a second fractional section of the open end of the shorted radiating portion and the feeding portion.

### BACKGROUND OF THE INVENTION

1. Field of the Invention

The present invention relates to a mobile communication device and an antenna structure, especially to a dual-band mobile communication device and an antenna structure that is applicable to the wireless wide area network (WWAN) operation.

2. Description of the Related Art

Currently, most of the mobile communication devices use the GSM (Global System for Mobile Communication) system, but a third-generation mobile communication system, UMTS, (Universal Mobile Telecommunication System) has also gained popularity among users. Therefore, it is essential for the antenna of a mobile communication device to cover both the GSM and UMTS bands.

In order to cover the operating bands of 824˜960 MHz and 1710˜2170 MHz, the traditional antenna usually occupies a large space inside the mobile communication device. In the prior technology, the coupling feed is used to reduce the antenna size and still maintain the multiband operation of the antenna.

However, the arrangement of the traditional antenna with a coupling feed usually cannot effectively reduce the length of the antenna along an edge of a mobile communication device. Hence, the occupied area of the antenna cannot be further reduced. For example, a coupling feed method for a multiband mobile communication device is disclosed by Taiwan Patent NO. 1295517. The internal multiband antenna disclosed by this patent covers four operating bands of GSM900/1800/1900/UMTS. However, with this traditional coupling feed method, it is difficult to include the five operating bands of GSM850/900/1800/1900/UMTS and also reduce the occupied area of the antenna.

Therefore, it is necessary to provide a dual-band mobile communication device and an antenna structure thereof, which will eliminate the problems encountered by prior technologies.

### SUMMARY OF THE INVENTION

The main object of the present invention is to provide a dual-band mobile communication device which can achieve GSM/UMTS multiband operation.

Another object of the present invention is to provide an antenna structure of a dual-band mobile communication device which can achieve GSM/UMTS multiband operation.

To achieve the above objectives, the dual-band mobile communication device of the present invention includes a ground plane and an antenna. The antenna is located on the dielectric substrate near the ground plane, and the antenna has a first frequency band and a second frequency band. The antenna comprises a feeding portion and a shorted radiating portion, wherein the length of the feeding portion is essentially one quarter-wavelength of the center frequency in the second frequency band. One end of the feeding portion is an antenna feeding point, and the feeding portion generates the second frequency band.

A length of the shorted radiating portion is at least twice the length of the feeding portion, and the length of the shorted radiating portion is essentially one quarter-wavelength of the center frequency in the first frequency band. A first end of the shorted radiating portion is the shorting end and is electrically connected to the ground plane.

A second end of the shorted radiating portion is an open end, and the shorted radiating portion includes multiple bendings. The open end of the shorted radiating portion extends towards a first fractional section in the shorting end of the shorted radiating portion. At the same time, a coupling gap is existed between a second fractional section of the open end of the shorted radiating portion and the feeding portion. Through the coupling gap, the shorted radiating portion is capacitively excited by the feeding portion so as to generate the first frequency band.

To achieve the other objective, the antenna structure of the present invention includes a dielectric substrate, a ground plane, and an antenna. The antenna is located on the dielectric substrate near the ground plane, and the antenna has a first frequency band and a second frequency band.

The antenna includes a feeding portion and a shorted radiation portion. One end of the feeding portion is the feeding point of the antenna, and the feeding portion generates a second frequency band.

A first end of the shorted radiating portion is the shorting end and is electrically connected to the ground plane, and a second end of the shorted radiating portion is the open end. The shorted radiating portion includes multiple bendings, which form multiple fractional sections.

The open end of the shorted radiating portion extends towards a first fractional section in the shorting end of the shorted radiating portion. A coupling gap is existed between a second fractional section of the open end of the shorted radiating portion and the feeding portion. The shorted radiating portion is capacitively excited by the feeding portion to generate the first frequency band.

### BRIEF DESCRIPTION OF THE DRAWINGS

FIG. 1 shows a structural diagram of the first embodiment of the present invention for a dual-band mobile communication device together with its antenna structure.

FIG. 2 shows a diagram of the measured return loss measurement for the first embodiment of the present invention.

FIG. 3 shows a structural diagram of the second embodiment of the present invention for a dual-band mobile communication device together with its antenna structure.

FIG. 4 shows a structural diagram of the third embodiment of the present invention for a dual-band mobile communication device together with its antenna structure.

### DETAILED DESCRIPTION OF THE PREFERRED EMBODIMENT

The advantages and innovative features of the invention will become more apparent from the following preferred embodiments.

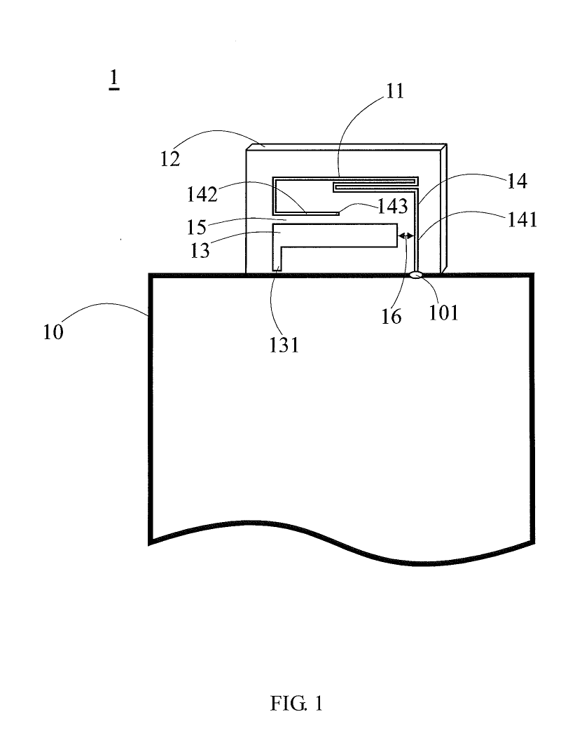

Refer to FIG. 1, which is the structural diagram of the first embodiment of the dual-band mobile communication device and its antenna structure. The dual-band mobile communication device 1 includes an antenna structure, and the antenna structure includes a ground plane 10, a dielectric substrate 12, and an antenna 11.

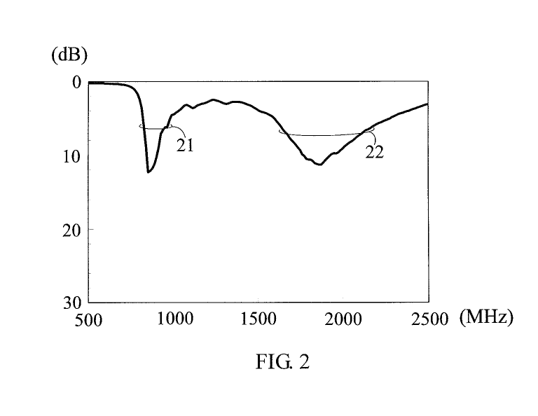

For example, the ground plane 10 can be a system ground plane for a mobile communication device, or a system ground plane for a mobile communication handset. Antenna 11 is located on the dielectric substrate 12 near the ground plane 10, and the antenna 11 has a first frequency band 21 and a second frequency band 22 (as shown in FIG. 2).

As shown in FIG. 1, the antenna 11 includes a feeding portion 13 and a shorted radiation portion 14. Please note that a length of the feeding portion 13 is about one quarter-wavelength of a center frequency of the second frequency band 22 of the antenna 11. In other words, the feeding portion 13 is used for generating the second frequency band 22, and the second frequency band 22 covers at least 1710˜2170 MHz. From FIG. 1, it can be seen that the feeding portion 13 has a first end and a second end, and the first end of the feeding portion 13 is a feeding point 131 of the antenna 11.

Furthermore, a length of the shorted radiating portion 14 is at least twice the length of the feeding portion 13, and the length of the shorted radiating portion 14 is about one quarter-wavelength of the center frequency of the first frequency band 21 of the antenna 11. A first end of the shorted radiating portion 14 is the shorting end 101, and it is electrically connected to the ground plane 10. A second end of the shorted radiating portion 14 is the open end 143.

The shorted radiating portion 14 includes multiple bendings. In the preferred embodiment, the shorted radiating portion 14 has seven bendings, thus dividing the shorted radiating portion 14 into multiple fractional sections (including 141 and 142). Please note that the open end 143 of the shorted radiating portion 14 extends toward the fractional section 141 in the shorting end of the shorted radiating portion. The distance 16 between the feeding portion 13 and the fractional section 141 in the shorting end must be less than 10 mm. At the same time, the distance of the coupling gap 15 between the feeding portion 13 and the fractional section 142 of the open end of the shorted radiating portion must be less than 3 mm.

Therefore, via the coupling gap 15, the shorted radiating portion 14 can be capacitively excited by the feeding portion 13. In other words, the shorted radiating portion 14 is used for generating a first frequency band 21, and the first frequency band 21 covers at least 824˜960 MHz.

Refer to FIG. 2, which shows the diagram of the measured return loss for the first embodiment of the present invention, wherein the horizontal axis represents the operating frequency, and the vertical axis represents the return loss.

In the first embodiment, the following dimensions were chosen for the experiment: the length and width of the ground plane 10 are approximately 100 mm and 40 mm; the occupied area of the antenna 11 is approximately 25×15 mm²; the dielectric substrate 12 has a length of 25 mm, a width of 15 mm, a thickness of 0.8 mm and a relative permittivity of 4.4; the feeding portion 13 has a length of 22.5 mm and a width of 3.5 mm; the shorted radiating portion 14 has a length of 85 mm and a width of 0.5 mm.

As shown in FIG. 2, the first embodiment of the present invention can generate the first frequency band 21 and the second frequency band 22. Under the 3:1 VSWR return loss definition (general specification of the antenna design for mobile communication devices), at least 824˜960 MHz and 1710˜2170 MHz must be covered. The two operating bands can cover the penta-band WWAN (wireless wide area network) operation, which includes the GSM850/900 (824˜960 MHz) dual-band operation and the GSM1800/1900/UMTS (1710˜2170MHz) tri-band operation.

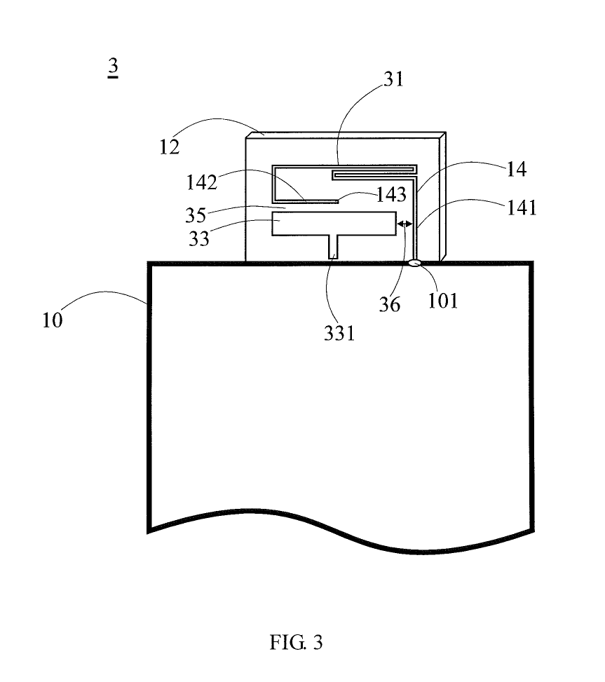

Refer to FIG. 3, which shows the structural diagram of the second embodiment of the present invention for a dual-band mobile communication device together with its antenna structure. The dual-band mobile communication device 3 includes an antenna structure, and the antenna structure includes a ground plane 10, a dielectric substrate 12, and an antenna 31. The antenna 31 is located on the dielectric substrate 12, and the antenna 31 includes a feeding portion 33 and a shorted radiating portion 14.

The basic structure of the second embodiment is similar to that of the first embodiment, wherein the major difference is that: the feeding portion 33 of the second embodiment is a T-shaped metal plate, whereas the feeding portion 13 of the first embodiment is an L-shaped metal plate.

Even though the shape of the feeding portion 33 is slightly changed in the second embodiment, the second frequency band 22 can still be generated by adjusting the dimensions of the feeding portion 33. The shorted radiating portion 14 can be capacitively excited by the feeding portion 33 so as to generate the first frequency band 21, thereby yielding a result similar to that in the first embodiment.

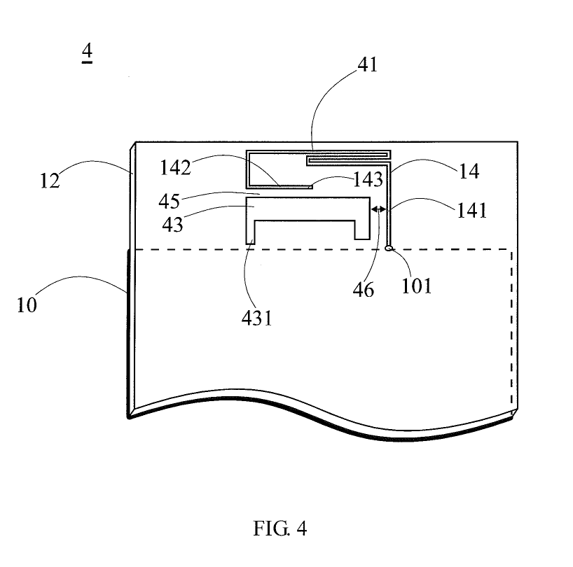

Refer to FIG. 4, which shows the structural diagram of the third embodiment of the present invention for a dual-band mobile communication device together with its antenna structure. The dual-band mobile communication device 4 includes an antenna structure, and the antenna structure comprises a ground plane 10, a dielectric substrate 12, and an antenna 41. The antenna 41 is located on the dielectric substrate 12, and the antenna 41 includes a feeding portion 43 and a shorted radiating portion 14.

The basic structure of the third embodiment is similar to that of the first embodiment, wherein the major difference is that: the feeding portion 43 of the third embodiment is an inverted U-shaped metal plate. Even though the shape of the feeding portion 43 has been changed in the third embodiment, the second frequency band 22 can still be achieved by adjusting the dimensions of the feeding portion 43. The shorted radiating portion 14 can be capacitively excited by the feeding portion 43 to generate the first frequency band 21, thereby yielding a result similar to that in the first embodiment.

In summary, the dual-band mobile communication device of the present invention utilizes a feeding portion to generate a second frequency band, which covers the GSM1800/1900/UMTS tri-band operation. The shorted radiating portion has multiple bendings, which form multiple fractional sections, causing the second fractional section at the open end of the shorted radiating portion to extend towards the fractional section at the shorting end of the shorted radiating portion, wherein a coupling gap is existed between the feeding portion and the shorted radiating portion.

As a result, with the presence of the coupling gap, the feeding portion is able to capacitively excite the shorted radiating portion. The shorted radiating portion can generate a first frequency band because the length of the shorted radiating portion is at least twice the length of the feeding portion, and the first frequency covers the GSM850/900 dual-band operation.

Through the first frequency band and the second frequency band generated by the feeding portion and the shorted radiating portion, as well as the open end extending towards the first fractional section at the shorting end of the shorted radiating portion, the antenna can fully cover the five-band WWAN operation. Furthermore, the multiple bendings of the shorted radiating portion decrease the length of the antenna along an edge of a mobile communication device, thereby achieving the objective of reducing the occupied area of the antenna.

Although the present invention has been explained in relation to its preferred embodiments, it is also of vital importance to acknowledge that many other possible modifications and variations can be made without departing from the spirit and scope of the invention as hereinafter claimed.

What is claimed is:

1. A dual-band mobile communication device, comprising a ground plane and an antenna, the antenna being located on a dielectric substrate close to the ground plane, and the antenna having a first frequency band and a second frequency band, the antenna comprising:
a feeding portion, wherein a length of the feeding portion is essentially one quarter-wavelength of a center frequency of the second frequency band, and one end of the feeding portion is a feeding point of the antenna, and the feeding portion generates the second frequency band; and
a shorted radiating portion, wherein the a length of the shorted radiating portion is at least twice the length of the feeding portion, and the length of the shorted radiating portion is essentially one quarter-wavelength of the a center frequency of the first frequency band; and a first end of the shorted radiating portion is a shorting end and is electrically connected to the ground plane, and a second end of the shorted radiating portion is an open end; wherein the shorted radiating portion comprises multiple bendings; the open end of the shorted radiating portion extends toward the a first fractional section of the shorting end of the shorted radiating portion; a coupling gap is existed between a second fractional section of the open end of the shorted radiating portion and the feeding portion; the shorted radiating portion is capacitively excited by the feeding portion so as to generate the first frequency band.

2. The dual-band mobile communication device as claimed in claim 1, wherein the coupling gap is less than 3 mm.

3. The dual-band mobile communication device as claimed in claim 1, wherein the shorted radiating portion comprises the open end comprising the second fractional section of length at least equal to 5 mm.

4. The dual-band mobile communication device as claimed in claim 1, wherein the feeding portion is an L-shape, a T-shape, or an inverted U-shape.

5. The dual-band mobile communication device as claimed in claim 1, wherein the first frequency band covers at least 824˜960 MHz, and the second frequency band covers at least 1710˜2170 MHz.

6. The dual-band mobile communication device as claimed in claim 1, wherein a distance between the first fractional section at the shorting end of the shorted radiating portion and the feeding portion must be less than 10 mm.

7. An antenna structure, comprising:
a ground plane;
a dielectric substrate; and
an antenna, being located on the dielectric substrate close to the ground plane, the antenna having a first frequency band and a second frequency band; the antenna comprising:
a feeding portion, wherein one end of the feeding portion is a feeding point of the antenna, and the feeding portion generates a second frequency band; and
a shorted radiating portion, wherein a first end of the shorted radiating portion is a shorting end, and a second end is an open end; the shorting end is electrically connected to the ground plane; the shorted radiating portion comprises multiple bendings which form multiple fractional sections, wherein the open end of the shorted radiating portion extends toward a first fractional section of the shorting end of the shorted radiating portion; a coupling gap is existed between a second fractional section of the open end of the shorted radiating portion and the feeding portion; wherein the shorted radiating portion is capacitively excited by the feeding portion so as to generate the first frequency band.

8. The antenna structure as claimed in claim 7, wherein a length of the feeding portion is essentially one quarter-wavelength of a center frequency in the second frequency band; a length of the shorted radiating portion must be at least twice the length of the feeding portion, and the length of the shorted radiating portion is essentially one quarter-wavelength of a center frequency in the first frequency band.

9. The antenna structure as claimed in claim 7, wherein the coupling gap is less than 3 mm.

10. The antenna structure as claimed in claim 7, wherein the shorted radiating portion comprises the open end comprising the second fractional section of length at least equal to 5 mm.

11. The antenna structure as claimed in claim 7, wherein the feeding portion is an L-shape, a T-shape, or an inverted U-shape.

12. The antenna structure as claimed in claim 7, wherein the first frequency band covers at least 824˜960 MHz, and the second frequency band covers at least 1710˜2170 MHz.

13. The antenna structure as claimed in claim 7, wherein a distance between the feeding portion and the first fractional section at the shorting end of the shorted radiating portion and the feeding portion must be less than 10 mm.
